(19) United States
(12) Patent Application Publication
(10) Pub. No.: US 2013/0140839 A1
(43) Pub. Date: Jun. 6, 2013

(54) SELF-CENTERING CLAMPING DEVICE

(71) Applicant: Longyear TM, Inc., South Jordan, UT (US)

(72) Inventors: Daragh Paul Quinn, Bassendean (AU); Matthew C. Everett, Willetton (AU)

(73) Assignee: Longyear TM, Inc., South Jordan, UT (US)

(21) Appl. No.: 13/679,853

(22) Filed: Nov. 16, 2012

Related U.S. Application Data
(60) Provisional application No. 61/561,396, filed on Nov. 18, 2011.

(51) Int. Cl. B66C 1/44

(52) U.S. Cl. CPC B66C 1/44; B66C 1/447
USPC 294/207

(57) ABSTRACT

A drill rod clamping device that is configured to clamp and secure drill rods, such that a drill rod of any diameter can be secured in the center of the device. The drill rod clamping device includes a pair of opposing jaws and either a back jaw or a locator block to ensure desired positioning of the drill rod relative to the drill rod clamping device. An actuating assembly selectively moves the opposing jaws toward each other and away from each other such that both of the opposing jaws move at substantially the same speed.

### CROSS-REFERENCE TO RELATED APPLICATIONS

This application claims the benefit of U.S. Provisional Application No. 61/561,396, filed Nov. 18, 2011, entitled “Self-Centering Clamping Device,” which application is herein incorporated by reference in its entirety.

### BACKGROUND

1. Field

This application relates generally to devices, systems, assemblies, and methods for clamping pipes. More particularly, this application relates to handling tools capable of clamping pipes of various sizes, while also centering the pipe.

2. Relevant Technology

Conventional drill rigs generally include an upstanding mast with a mounted drill head. The drill head is capable of moving along the mast. Additionally, the drill head can receive and engage the upper end of a drill string. The drill head can rotate the drill string and a drill bit mounted to the drill string to drill within a formation. The drill string can include a plurality of drill rods that are connected end to end.

During a drilling operation, when the drill head has reached the lower end of the mast, the drill string is clamped and the drill head is disconnected from the drill string. An additional length of drill rod is then added to the end of the drill string, the drill head is connected to the new rod, and the drilling process is resumed once again. During drilling operation, depending on the depth of the bore hole, numerous drill rods may be added to the drill string in order to reach a desired depth.

Oftentimes, the drill rig may be mounted to a chassis of a motorized vehicle, such as a truck or lorry. The drill rods may be kept in a storage zone and may lie horizontally in a stack close to the drilling mast. When a new drill rod has to be added to the drill string, an operator can pick a drill rod from the stacked array and connect it to the end of the last drill rod in the drill string. The addition may be performed manually, where such operation is feasible, or with an aid of a mechanized loading arm configured to clamp and manipulate the drill rods.

A drill rig and/or drill head may be configured to accept and use drill rods of various diameters and length. A typical drill rod can have a male, a female, or combination of male and female threads on each end, which can be used to connect the rods into a drill string. When a new drill rod is added to the drill string, it has to be positioned substantially concentrically with the previous drill rod, in order for the operator to engage and screw the threaded end of the new drill rod into the end of the previous drill rod.

Frequently, drill rods are threaded steel tubes or pipes that may have thin walls in order to reduce material related costs and allow for coring. Mishandling of the drill rods during positioning thereof for connection to the drill string can result in damaging of the drill rods. Additionally or alternatively, misalignment of the end of a new drill rod with respect to the drill sting may result in damage to the threads of the drill rods when the new drill rod is screwed onto the end of the drill string.

### SUMMARY

Disclosed herein is a drill rod clamping device that is configured to clamp and secure drill rods, such that a drill rod of any diameter can be secured in the center of the device. The drill rod clamping device can include a pair of opposing jaws. The drill rod clamping device can also include an actuating assembly that can move the opposing jaws inward (i.e., toward each other) and outward (i.e., away from each other), such that a distance between the opposing jaws can be selectively reduced or increased. In some instances, the back jaw can be stationary. The drill rod clamping device can further include a back jaw or a locator block to promote desired positioning of a drill rod between the opposing jaws.

Additional features and advantages of exemplary aspects of the invention will be set forth in the description which follows, and in part will be obvious from the description, or may be learned by the practice of such exemplary aspects. The features and advantages of such aspects may be realized and obtained by means of the instruments and combinations particularly pointed out in the claims. These and other features will become more fully apparent from the following description and appended claims, or may be learned by the practice of such exemplary aspects as set forth hereinafter.

### BRIEF DESCRIPTION OF THE DRAWINGS

These and other features of the disclosure will become more apparent in the detailed description in which reference is made to the appended drawings wherein:

FIG. 1A illustrates a top cross-sectional view of a self-centering drill rod clamping device in an open position as described herein;

FIG. 1B illustrates a front view of the self-centering drill rod clamping device of FIG. 1A;

FIG. 2A illustrates a top cross-sectional view of the self-centering drill rod clamping device of FIG. 1A in a closed position as described herein;

FIG. 2B illustrates a front view of the self-centering drill rod clamping device of FIG. 2A;

FIG. 3 illustrates a schematic diagram of a separator wedge positioned between a last drill rod and an adjacent drill rod as described herein;

FIG. 4A illustrates a front view of another exemplary self-centering drill rod clamping device in an open position as described herein; and

FIG. 4B illustrates a front view of the self-centering drill rod clamping device of FIG. 4A in a closed position.

FIG. 5A illustrates a top perspective view of the exemplary self-centering drill rod clamping device of FIG. 4A. FIG. 5B illustrates a bottom perspective view of the self-centering drill rod clamping device of FIG. 5A.

FIG. 6 is a partial cutaway bottom perspective view of the self-centering drill rod clamping device of FIGS. 5A and 5B.

FIG. 7 is a partially transparent side cross-sectional view of the self-centering drill rod clamping device of FIGS. 5A and 5B, taken along a central longitudinal axis of the self-centering drill rod clamping device.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a locator block” can include two or more such locator blocks unless the context indicates otherwise.

As used herein, the terms “optional” or “optionally” mean that the subsequently described event or circumstance may or may not occur, and that the description includes instances where said event or circumstance occurs and instances where it does not.

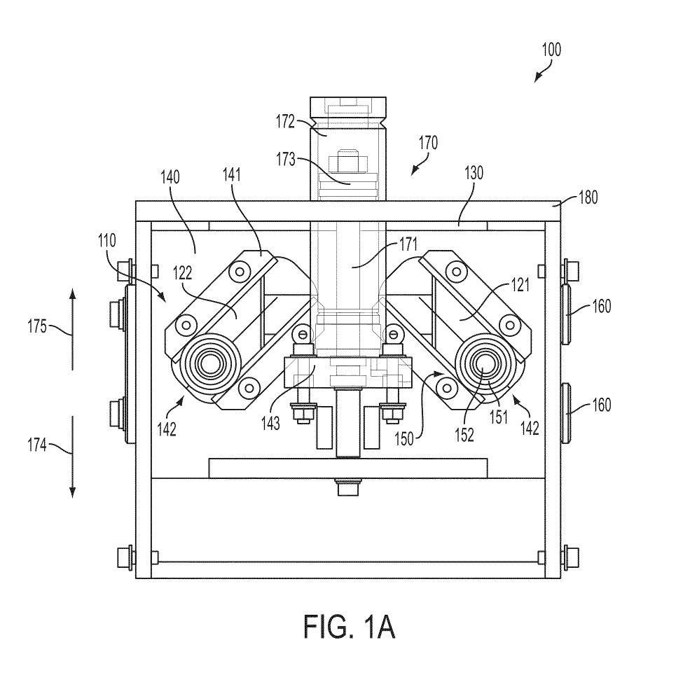

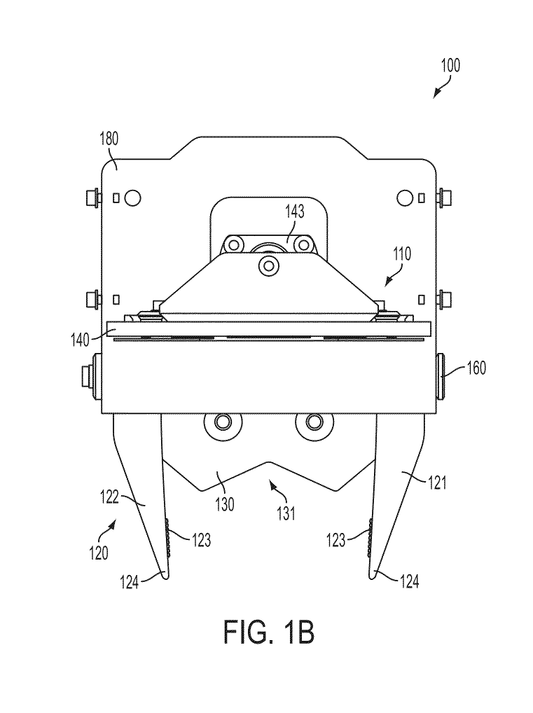

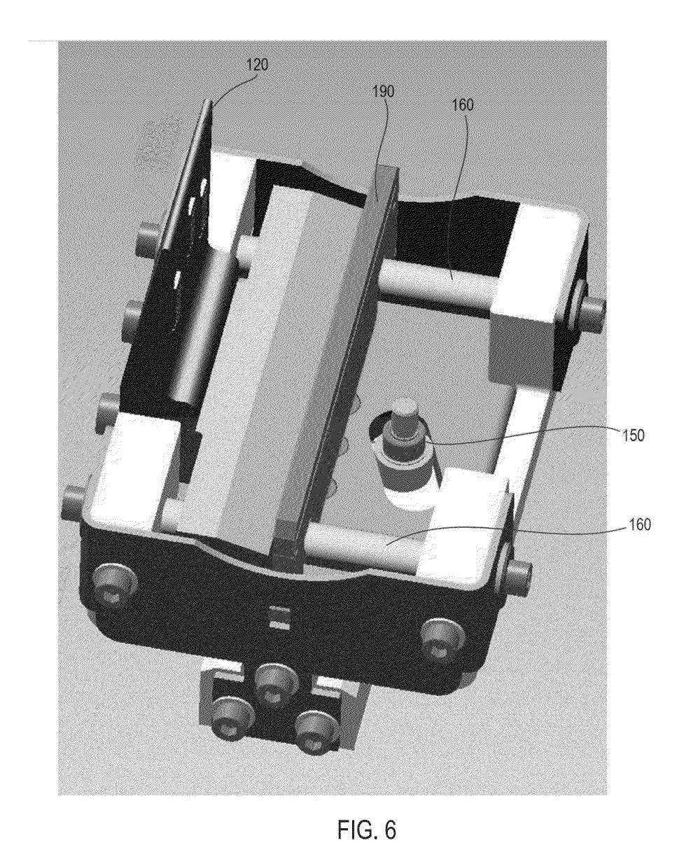

With reference to FIGS. 1A-7, disclosed herein is a drill rod clamping device that is configured to clamp and secure drill rods such that a drill rod of any diameter can be secured in a center portion of the device. In exemplary aspects, the drill rod clamping device can comprise a pair of opposing jaws and a back jaw or locator block, as further described herein. In these aspects, the drill rod clamping device can further comprise an actuating assembly that can move the opposing jaws inward (i.e., toward each other) and outward (i.e., away from each other), such that a distance between the opposing jaws can be selectively reduced or increased. In some instances, it is contemplated that the back jaw can be substantially stationary.

In one exemplary aspect, the drill rod clamping device can have two opposing jaws slideably connected to a single actuating assembly, which can move the opposing jaws, thereby clamping the drill rod. It is contemplated that the drill rod clamping deice can be configured to substantially uniformly clamp rods of any diameter. In exemplary aspects, the drill rod clamping device can be configured to allow for clamping of drill rods having outer diameters ranging from about 40 mm to about 160 mm. Additionally, it is contemplated that the drill rods can be clamped by the drill rod clamping devices such that a center portion of any drill rod is always in the same position with respect to the drill rod clamping device. Optionally, in additional exemplary aspects, a center portion of the clamped drill rod can be substantially aligned with a center portion of the drill rod clamping device.

In another aspect, the actuating assembly can comprise a floating plate and a cylinder secured to the floating plate. The cylinder can be configured to selectively move the floating plate in a first direction and in a second direction. In exemplary aspects, movement of the floating plate in the first direction can urge the opposing jaws inwardly, and movement of the floating plate in the second direction can urge the opposing jaws outwardly.

Optionally, in additional aspects, the drill rod clamping device can comprise a back jaw having v-shaped portion that can aid in centering the drill rod with respect to the drill rod clamping device. In these aspects, the center portion of the drill rod can be positioned in substantially the same location with respect to the drill rod clamping device, irrespective of the diameter of the drill rod. Additionally, it is contemplated that the opposing jaws can be configured to clamp the drill rod in a manner that will force or otherwise urge the drill rod into the v-shaped portion of the back jaw.

In exemplary aspects, the actuating assembly can be configured to substantially uniformly move the opposing jaws, such that each jaw is moved at substantially the same speed. The uniform motion of the opposing jaws can aid in centering the drill rod with respect to the drill rod clamping device.

Optionally, in one aspect, the drill rod clamping device can use the same set of opposing jaws to clamp drill rods having a variety of outer diameters. In further aspects, the opposing jaws and/or drill rod clamping device can be configured such that substantially the same portion of the jaws can contact and clamp drill rods of any diameter. In exemplary aspects, the opposing jaws can be configured to apply clamping forces on a drill rod that are not parallel one to another.

In another aspect, the opposing jaws can have a unique shape or geometry, such that the geometry of the opposing jaws can create a wedge angle with respect to the drill rod and/or with respect to the back jaw. In an exemplary aspect, the wedge angle can be such that gripping points (i.e., the points of contact between the opposing jaws and the drill rod) can be the same irrespective of a jaw size and/or drill rod diameter. In other words, it is contemplated that the same opposing jaws can be used to clamp drill rods of any outer diameter, and the contact points of the opposing jaws and the drill rod can remain substantially the same, regardless of the diameter of the drill rod that is being clamped.

In exemplary aspects, the opposing jaws can apply clamping forces that are substantially perpendicular to one or more faces of the v-shaped portion of the back jaw. In other aspects, the opposing jaws can apply clamping forces at acute or obtuse angles with respect to one or more faces of the v-shaped portion of the back jaw. Hence, in some aspects, a drill rod can be forced into the v-shaped portion of the back jaw, which can aid in centering the drill rod and provide improved clamping of the drill rod. Additionally or alternatively, it is contemplated that the opposing jaws can be disposed substantially parallel or at an acute angle with respect to each other.

In additional aspects, the back jaw can be moved such that the center portion of a drill rod is positioned in substantially the same location with respect to the drill rod clamping device, irrespective of the diameter of the drill rod. In these aspects, the opposing jaws can be configured to enter a stack of drill rods and isolate a single drill rod therein. For example, it is contemplated that leading edges of the opposing jaws can have a wedge-like shape, which can push aside drill rods that are adjacent to a target drill rod. Hence, it is contemplated that the drill rod clamping device can enter a drill rod stack, which also can eliminate a need to split groupings of different rod sizes or split a particular rod prior to retrieval.

Optionally, in exemplary aspects, rather than a back jaw, the drill rod clamping device can comprise a locator block configured for attachment to a portion of the drill rod clamping device. In these aspects, it is contemplated that bottom end of the locator block can project into a receiving space defined by the two opposing jaws such that a drill rod contacts and engages the locator block as it is advanced toward the center portion of the drill rod clamping device. At least a portion of the locator block can be operatively coupled to a selected portion of the drill rod clamping device such that the locator block is substantially stationary during operation of the drill rod clamping device. It is still further contemplated that the locator block can have a longitudinal length substantially corresponding to a longitudinal length of the drill rod clamping device.

In exemplary aspects, the locator block can be a clip-in element having a pair of spaced hook elements spaced from one another on opposite ends of the longitudinal length of the locator block. It is contemplated that at least a portion of each hook element can be configured for receipt within and engagement with a corresponding slot defined by a portion of the drill rod clamping device. It is contemplated that the locator block can extend substantially perpendicularly relative to the first and second directions of movement by the two opposed jaws. It is further contemplated that the locator block can comprise one or more flexible materials. Optionally, the locator block can comprise nylon. Like the back jaw, the locator block helps stabilize the drill rod during clamping of the drill rod by the opposing jaws and helps ensure that the drill rod is centrally positioned in a desired orientation relative to the drill rod clamping device. In exemplary aspects, the locator block can define one or more channels configured to receive a corresponding guide rod of the drill rod clamping device. In these aspects, the locator block can be configured to rest on the one or more guide rods of the drill rod clamping device.

In one aspect, the drill rod clamping device can be configured as a standalone unit that can be attachable to and removable from a loader arm, which can be configured to move the drill rods into a desired position on the drilling rig. It is contemplated that the loader arm can place a new drill rod concentrically with the previous drill rod in the drill string, such that a user can secure the end of the new drill rod to the end of the previous drill rod. Alternatively, the drill rod clamping device can be integrated into the loader arm.

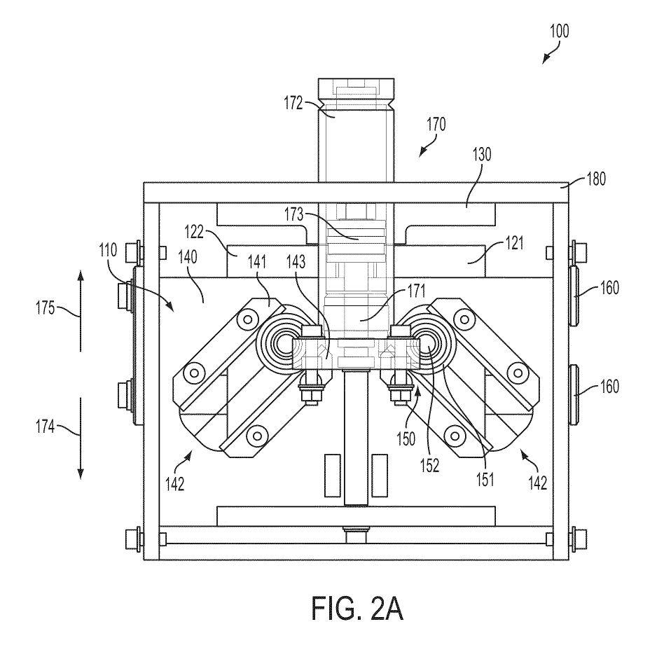

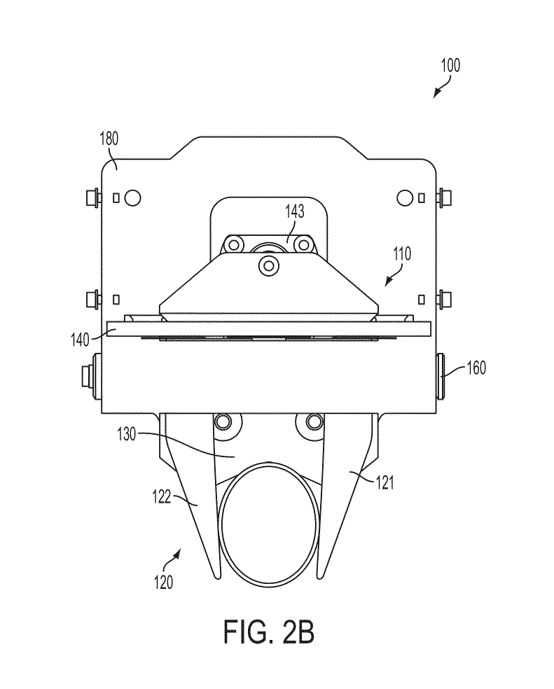

FIGS. 1A and 1B illustrate an exemplary drill rod clamping device 100 in an open position. The drill rod clamping device 100 can comprise an actuating assembly 110 operatively associated with opposing jaws 120. The drill rod clamping device 100 can further comprise a back jaw 130 or a locator block 190. In operation, when the actuating assembly 110 is activated, it can be configured to urge the opposing jaws 120 toward one another and into a closed position, thereby clamping a drill rod. FIGS. 2A and 2B illustrate the drill rod clamping device 100 in the closed position.

In exemplary aspects, the drill rod clamping device 100 can comprise a right jaw 121 and a left jaw 122 that cooperate to define a receiving space 125. In these aspects, the right and left jaws 121, 122 of the opposing jaws 120 can be urged toward one another by the actuating assembly 110. In additional aspects, the actuating assembly 110 can be configured to urge or move both the right and left jaws 121, 122 of the opposing jaws 120 at substantially the same speed and in opposite directions with respect to the drill rod clamping device 100. Thus, as illustrated in FIGS. 1B and 2B, as the right jaw 121 is moved in a first direction the left jaw 122 is moved in a second direction, which is opposite to the first direction.

In another aspect, the actuating assembly 110 can be configured to engage both the right and left, jaws 121, 122 and maintain the right and left jaws 121, 122 the same distance from a predetermined point during opening, closing, or clamping. Thus, it is contemplated that the actuating assembly 110 can cause the right and left jaws 121, 122 to make contact with the drill rod approximately simultaneously, as illustrated in FIG. 2B. It is further contemplated that contacting the drill rod simultaneously with both the right and left jaws 121, 122 can reduce the impact on the drill rod as well as damage that may result there from.

In additional or alternative aspects, the right and left jaws 121, 122 can be configured such that in the closed position, each can exert approximately the same amount of force on the drill rod. Thus, it is contemplated that the total clamping force exerted by the right and left jaws 121, 122 of the opposing jaws 120 on the drill rod can be equally distributed between the right jaw 121 and the left jaw 122. In addition to aiding in centering a drill rod with respect to the drill rod clamping device 100, it is contemplated that equal distribution of force between the right and left jaws 121, 122 can also reduce wear-and-tear and prevent damage of the drill rods, which can be caused by uneven application of clamping forces.

As can best be seen in FIGS. 1A and 2A, in one exemplary aspect, the drill rod clamping device 100 has only a single actuating assembly 110, which is configured to move the opposing jaws 120 toward and away from each other. In additional aspects, the actuating assembly 110 can include a floating plate 140 and a cylinder 170 that is secured to the floating plate 140. In these aspects, the cylinder 170 can comprise a piston 171 disposed within a barrel 172. Additionally, it is contemplated that the cylinder 170 can have a seal 173, which may partially or wholly block passage of at least one fluid, such as liquids, gases, and mixtures thereof, within the barrel 172. In operation, at least one fluid can be forced toward or away from the piston 171, which can, consequently, move the piston 171 in a third direction 174 or fourth direction 175.

In a further aspect, the piston 171 can be secured to a connector block 143, which can be secured to or integrated with the floating plate 140. Consequently, movement of the piston 171 can result in a corresponding motion of the floating plate 140 in the third and fourth directions 174, 175. Thus, it is contemplated that, as the piston 171 moves in the third direction 174, the floating plate 140 can also move in the third direction 174. Conversely, when the piston 171 moves in the fourth direction 175, the floating plate 140 can also move in the fourth direction 175, in response to the movement of the piston 171.

In one aspect, the floating plate 140 can comprise gibs 141 that define two guide channels 142. In this aspect, the guide channels 142 can be disposed at an acute or obtuse angle with respect to the cylinder 170 and, consequently, with respect to the third and fourth directions 174, 175. In one exemplary aspect, each of the guide channels 142 can be disposed at about a 45 degree angle with respect to the third and fourth directions 174, 175.

In additional aspects, the drill rod clamping device 100 can comprise one or more bearings 150, which can be configured to slide within each of the guide channels 142. Optionally, in exemplary aspects, the bearings 150 can be secured to the respective right and left jaws 121, 122. In these aspects, the bearings 150 can move only radially with respect to their centers and can be otherwise stationary with respect to the right and left jaws 121, 122. Thus, it is contemplated that the respective bearings 150 can be fixed at a point on the right and left jaws 121, 122 but may have the freedom to rotate around the point.

In a further aspect, the bearings 150 can further comprise inner rings 152 and outer rings 151. Optionally, each of the inner rings 152 can be secured to or integrated with at least one of the opposing jaws 120. In various aspects, the inner rings 152 can be substantially stationary, such that each of the inner rings 152 is configured for no movement with respect to the opposing jaw 120 that it is secured to or integrated within one exemplary aspect, however, one or more of the inner rings 152 can be movable with respect to the opposing jaw 120 that it is secured to or integrated with. Optionally, in this aspect, the inner ring 152 can be secured to the right or left jaw 121, 122 in a manner that permits the inner ring 152 to rotate about its center. In exemplary aspects, the outer rings 151 can be configured to rotate substantially freely about their center portions.

Optionally, it is contemplated that, as the floating plate 140 is moved in the third direction 174 by the cylinder 170, the bearings 150 can be guided along the respective guide channels 142 and can be forced closer to one another, as can be seen from the change in positions of the bearings 150 illustrated in FIGS. 1A and 2A. In some aspects, movement of the bearings 150 with respect to the drill rod clamping device 100, which is generated by the floating plate 140, can be substantially or entirely along the first and second directions. As described above, in various aspects, the bearings 150 can be secured to the right and left jaws 121,122. Consequently, it is contemplated that, as the bearings 150 are guided toward one another along the respective first and second directions, the right and left jaws 121, 122 can be moved or urged toward one another along the first and second directions, respectively.

In further aspects, as described above, the cylinder 170 can also move the floating plate 40 in the fourth direction 175. In one aspect, while the floating plate 140 moves in the fourth direction 175, the bearings 150 can be guided along their respective guide channels 142. Hence, it is contemplated that as the floating plate 140 moves in the fourth direction 175, the bearings 150 can move in respective first and second directions. Furthermore, as described above, in various aspects, the bearings 150 can be secured to the right and left jaws 121,122. Consequently, it is contemplated that, when the floating plate 140 moves in the fourth direction 175, the right jaw 121 can be moved in the first direction and the left jaw 122 can be moved in the second direction such that the right and left jaws 121, 122 are moved toward the open position.

In exemplary aspects, the drill rod clamping device 100 can comprise one or more guide rods 160. In these aspects, the guide rods 160 can be disposed substantially parallel to the first and second directions (the directions in which the right jaw 121 and left jaw 122 respectively move during movement from the open position to the closed position). It is contemplated that the opposing jaws 120 can be slideably disposed in connection with the guide rods 160 such that the opposing jaws 120 can move along the longitudinal lengths of the guide rods 160. It is further contemplated that the guide rods 160 can be substantially cylindrical and can be secured to the drill rod clamping device 100. In additional exemplary aspects, the opposing jaws 120 can comprise one or more apertures (not shown) configured to accept the guide rods 160 in a manner that permits the opposing jaws 120 to move along the guide rods 160.

In further aspects, the apertures and the guide rods 160 of the drill rod clamping device 100 can have a sliding fit such that movement of the opposing jaws 120 can be limited in one or more directions other than the first and second directions. In one exemplary aspect, the guide rods 160 can have diameters of about 1.5 inches, and the apertures can have diameters of less than 1.5 inches, such as, for example and without limitations, diameters of about 1.498 inches. Additionally, the apertures can comprise one or more bushings (not shown) that can be removable and/or replaceable and which can be configured to slide along the guide rods 160. Furthermore, in additional aspects, the guide rods 160 and/or apertures (or bushings, where applicable) can be lubricated such that friction is reduced between the guide rods and/or apertures (or bushings). In additional aspects, the guide rods 160 can be configured to allow more precise motion of the opposing jaws 120 and to reduce potential binding and/or jamming of the opposing jaws 120.

To aid with centering the drill rod with respect to a point (or an axis) on the drill rod clamping device 100, the drill rod clamping device 100 can optionally comprise a back jaw 130 that has a v-shaped portion 131, as illustrated in FIG. 1B. It is contemplated that opposed, inwardly facing surfaces of the v-shaped portion 131 can form an acute, obtuse, or a right angle relative to one another. It is further contemplated that the back jaw 130 and/or the v-shaped portion 131 can be configured to engage drill rods having a specific diameter or a variety of drill rods having different diameters.

In another aspect, the back jaw 130 can be substantially stationary. In this aspect, it is contemplated that the back jaw 130 can be secured to the drill rod clamping device 100 such that the back jaw 130 is not permitted to move with respect to the drill rod clamping device 100. It is contemplated that the back jaw 130 can be removable and replaceable, such that one back jaw 130 can be removed and/or replaced with another back jaw 130. It is further contemplated that the back jaw 130 can be selectively secured to the drill rod clamping device 100, such that the back jaw 130 can be moved in the third and fourth directions 174, 175, as well as in a direction substantially perpendicular to the first and second directions (by which the right jaw 121 and left jaw 122 respectively move during movement from the open position to the closed position) and to the third and fourth directions 174, 175.

In still another aspect, the back jaw 130 can be configured to move toward or away from the drill rod as it is being secured by the drill rod clamping device 100. In this aspect, it is contemplated that the back jaw 130 can be moved by the actuating assembly 110 in response to the movement of the cylinder 170. Thus, it is contemplated that the back jaw 130 can move toward the drill rod such that the opposing jaws 120 can grip a drill rod in the same position irrespective of the size of the drill rod.

In a further aspect, it is contemplated that the same back jaw 130 can be used with drill rods of various diameters. In exemplary aspects, the v-shaped portion 131 of the back jaw 130 can be sufficiently large to accept drill rods having an outer diameter of about 160 mm. In these aspects, the v-shaped portion 131 of the back jaw 130 can also have opposing faces that can facilitate positioning of the drill rods and contact with drill rods of smaller diameters, such as drill rods having outer diameters of about 40 mm. Thus, in various aspects, the drill clamping device 100 can be used to grab drill rods of various diameters without requiring changing and/or moving the back jaw 130.

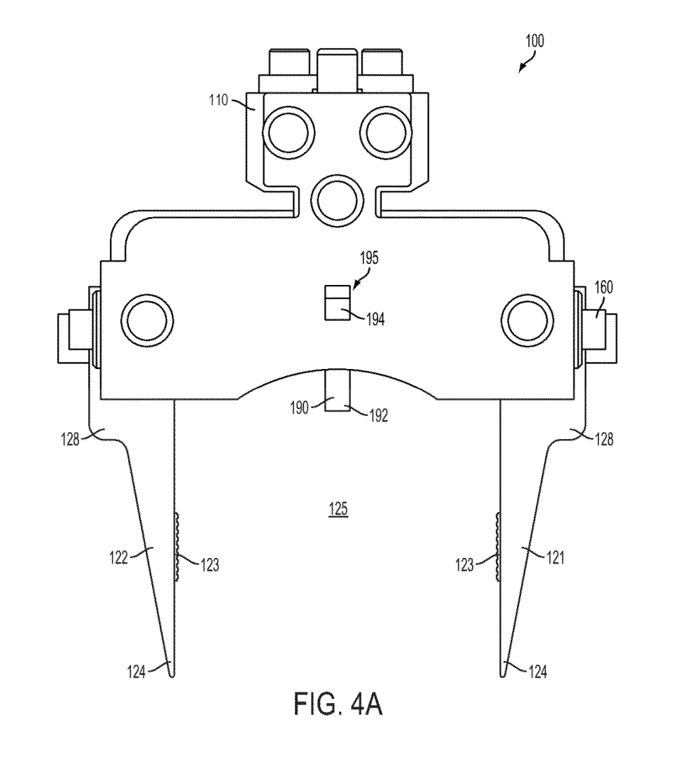

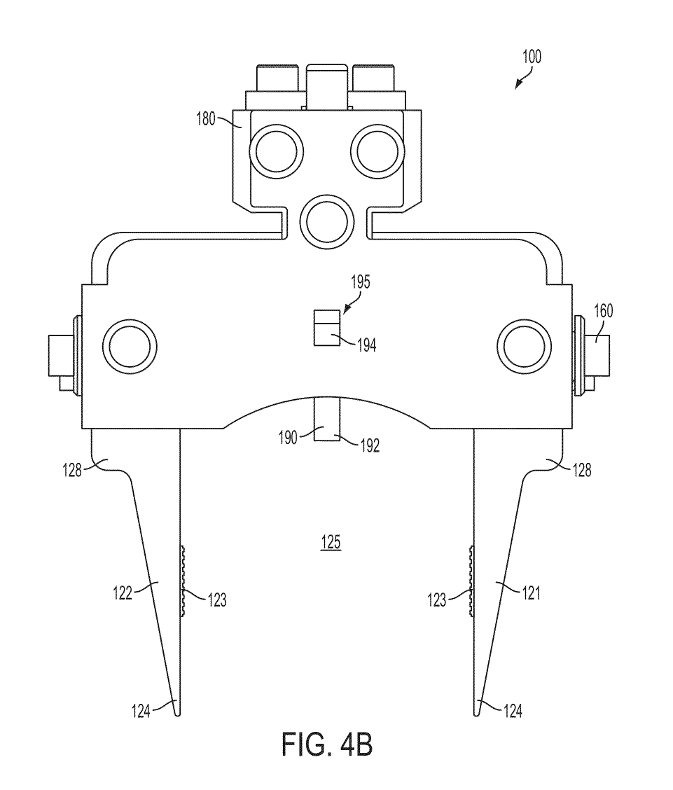

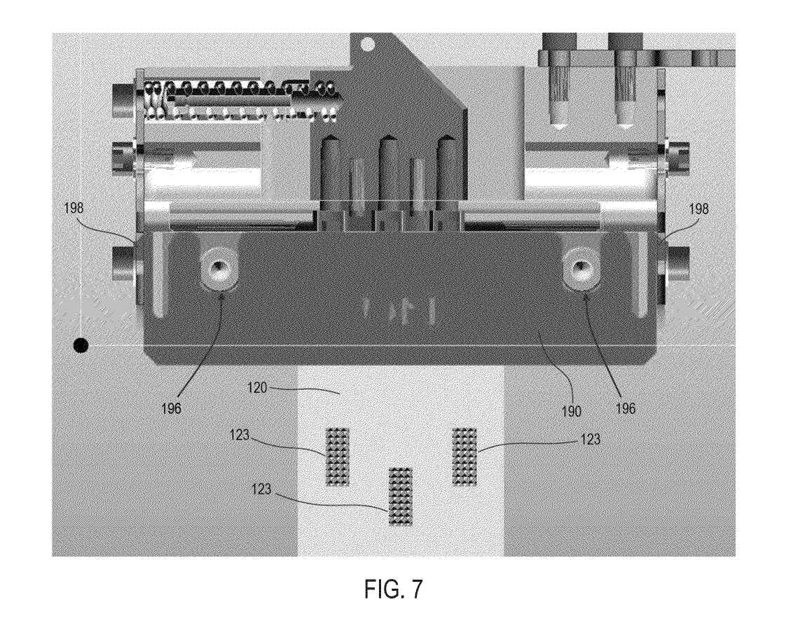

Alternatively, as shown in FIGS. 4A-7, in place of a back jaw 130, the drill rod clamping device 100 can optionally comprise a locator block 190 configured for attachment to a portion of the drill rod clamping device. As shown in FIG. 7, it is contemplated that the longitudinal length of the locator block 190 can substantially correspond to the longitudinal length of the drill rod clamping device 100. As shown in FIGS. 4A-7, when the locator block 190 is placed in an operative position, a bottom end 192 of the locator block can be configured to project from the drill rod clamping device 100 and extend substantially perpendicularly relative to the first and second directions of movement by the two opposed jaws 121, 122. Like the back jaw, the locator block 190 can be configured to engage drill rods having a specific diameter or to engage individual drill rods having a variety of external diameters. In exemplary aspects, it is further contemplated that the v-shaped portion 131 of the back jaw 130, as well as the locator block 190, can be configured to engage drill rods having a variable outer diameter.

In exemplary aspects, it is contemplated that the bottom end 192 of the locator block 190 can be configured to project into a receiving space 125 defined by the two opposing jaws 121, 122 such that a drill rod contacts and engages the locator block as it is advanced toward the center portion of the drill rod clamping device 100. In these aspects, at least a portion of the locator block 190 can be operatively coupled to a selected portion of the drill rod clamping device 100 such that the locator block is substantially stationary during operation of the drill rod clamping device. In exemplary aspects, the locator block 190 can be a clip-in element having a pair of spaced hook elements 194 spaced from one another on opposite ends of the longitudinal length of the locator block. It is contemplated that at least a portion of each hook element 194 can be configured for receipt within and engagement with a corresponding slot 195 defined by a portion of the drill rod clamping device 100. In exemplary aspects, as shown in FIG. 7, a projection 198 of each hook element 194 can be configured to securely abut and engage one or more surfaces of a corresponding slot 195. Optionally, in one aspect, the locator block 190 can comprise nylon. Like the back jaw, it is contemplated that the locator block 190 can help stabilize the drill rod during clamping of the drill rod by the opposing jaws 121, 122 while ensuring that the drill rod is centrally positioned in a desired orientation relative to the drill rod clamping device 100.

In exemplary aspects, the locator block 190 can define one or more channels 196 configured to receive a corresponding guide rod 160 of the drill rod clamping device 100. In these aspects, it is contemplated that the locator block 190 can be configured to rest on the one or more guide rods 160 of the drill rod clamping device 100.

Optionally, in another aspect, after coupling the locator block 190 to the drill rod clamping device 100, the locator block 190 can be substantially stationary. In this aspect, it is contemplated that the locator block 190 can be secured to the drill rod clamping device 100 such that the locator block 190 is not permitted to move with respect to the drill rod clamping device 100. It is contemplated that the locator block 190 can be removable and replaceable, such that one locator block 190 can be removed and/or replaced with another locator block 190. In exemplary aspects, it is contemplated that the position of the locator block 190 can be selectively adjustable in the third and fourth directions 174, 175. It is further contemplated that the drill rod clamping device 100 can define a plurality of spaced slots 195 that are configured to receive the hook elements 194 of the locator block 190 such that the position of the locator block can be selectively adjusted in a direction substantially perpendicular to the first and second directions (by which the right jaw 121 and left jaw 122 respectively move during movement from the open position to the closed position) and to the third and fourth directions 174, 175.

Optionally, in other exemplary aspects, the locator block 190 can be flexible. In these aspects, the locator block 190 can be configured for a desired amount of compression in a direction substantially perpendicular to the first and second directions (by which the right jaw 121 and left jaw 122 respectively move during movement from the open position to the closed position).

In a further aspect, it is contemplated that the same locator block 190 can be used with drill rods of various diameters. In exemplary aspects, the locator block 190 can be shaped to permit receipt within the receiving space 125 of drill rods having an outer diameter of about 160 mm. In these aspects, the locator block 190 can also be positioned for engaging contact with drill rods of smaller diameters, such as drill rods having outer diameters of about 40 mm. Thus, in various aspects, the drill clamping device 100 can be used to grab drill rods of various diameters without requiring changing and/or moving the locator block 190.

As illustrated in FIGS. 1B, 2B, and 4A-7, in exemplary aspects, the opposing jaws 120 can have one or more clamping surfaces 123. In these aspects, each clamping surface can be textured, dimpled, and/or have one or more shapes formed thereon, thereby promoting improved clamping by increasing the coefficient of friction of the opposing jaws 120. It is contemplated that the one or more clamping surfaces 123 can comprise at least one material that is softer than the materials of the opposing jaws 120 and/or the drill rod. In exemplary aspects, the at least one material of the one or more clamping surfaces can comprise elastomeric and thermoplastic materials, polymers (e.g., wood), and soft metals (e.g., lead, copper, brass). In exemplary aspects, as shown in FIGS. 4A-7, the one or more clamping surfaces 123 can comprise a plurality of clamping surfaces 123. In these aspects, it is contemplated that at least one clamping surface of the plurality of clamping surfaces 123 can be offset from another clamping surface of the plurality of clamping surfaces. In further exemplary aspects, it is contemplated that a first clamping surface of the plurality of clamping surfaces 123 can have sufficient length to grip a drill rod and be positioned such that it can engage the drill rod through a center axis of the drill rod. It is still further contemplated that a second clamping surface 123 of the plurality of clamping surfaces can be offset from the first clamping surface such that the second clamping surface supports and/or stabilizes the drill rod during initial manipulation of the rod into the receiving space 125.

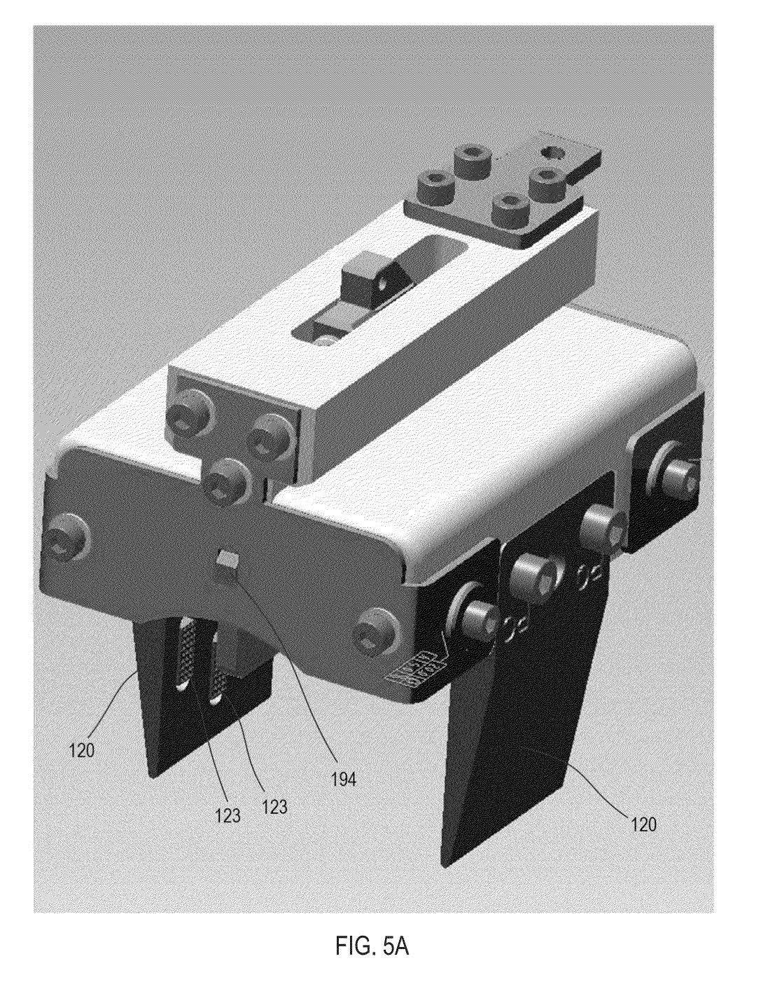

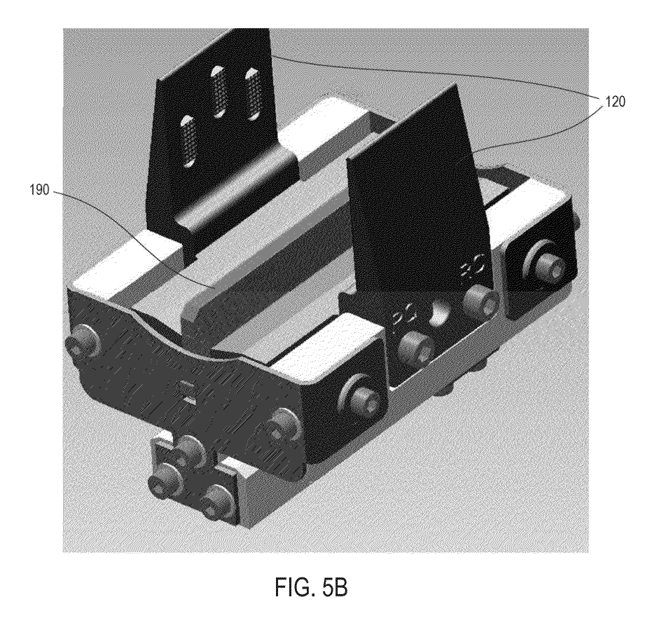

In one exemplary aspect, the opposing jaws 120 can have a leading edge 124. In this aspect, it is contemplated that the leading edge 124 can optionally be tapered, as shown in FIGS. 1A-3. However, it is also contemplated that the leading edge 124 can optionally be substantially untapered. It is further contemplated that the leading edge 124 can be configured to facilitate entry of the opposing jaws 120 into a stack of drill rods while also isolating a single drill rod from the stack. In operation, as the opposing jaws 120 enter the drill rod stack, it is contemplated that the tapered leading edge 124 can be configured to push aside drill rods that are adjacent to the drill rod that an operator intends to clamp. In exemplary aspects, the opposing jaws 120 can have a base portion 128 configured for operative coupling to one or more of the guide rods 160. In these aspects, as shown in FIGS. 4A-4B and 5A, it is contemplated that the base portions 128 of the opposing jaws 120 can project inwardly (toward the receiving space 125) and/or outwardly (away from the receiving space 125) relative to adjacent portions of the opposing jaws.

In further aspects, an enclosure 180 can be provided for securing and/or enclosing one or more components of the drill rod clamping device 100. In exemplary aspects, and with reference to FIGS. 4A-7, the drill rod clamping device 100 can be an attachable and removable unit that is configured for secure receipt within a drill rod loading arm. In these aspects, and with reference to FIG. 4A, a drill rod loading arm can be configured to receive a top portion 110 of the drill rod clamping device 100 such that the drill rod clamping device is movable relative to a longitudinal axis of the drill rod loading arm. In exemplary aspects, it is contemplated that the drill rod clamping device 100 can be operatively coupled to a chain and/or cable to permit axial movement of the drill rod clamping device relative to the drill rod loading arm. Alternatively, in additional aspects, and with reference to FIGS. 1A-2B, the drill rod clamping device 100 can be configured for integration into or secure attachment to affixed drill rod loading arm. In these aspects, the drill rod clamping device 100 (and/or enclosure 180) can be configured to abut and be secured to a portion of the drill rod loading arm. Optionally, in exemplary aspects, the enclosure 180 can define at least one pair of opposed slots 195 configured to receive corresponding portions of the locator block 190 (e.g., hook portions 194) as described herein. In further exemplary aspects, as shown in FIGS. 4A and 4B, a central portion of the enclosure 180 (and a central portion of the drill rod clamping device 100) can be recessed relative to the receiving space 125.

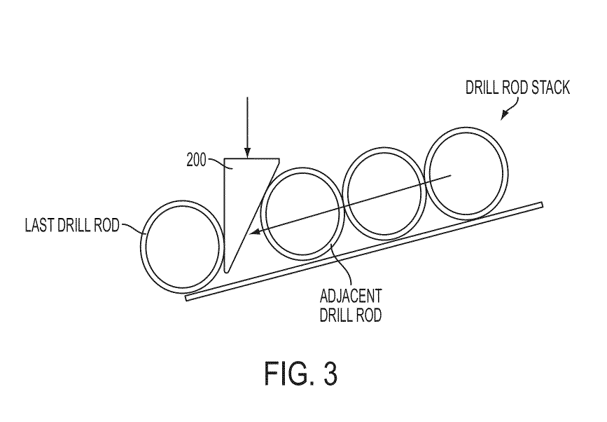

Optionally, in additional aspects, a separator wedge 200, illustrated in FIG. 3, can be secured to the loading arm and/or to the drill rod clamping device 100. In these aspects, it is contemplated that the separator wedge 200 can be configured to aid in isolating a specific drill rod from the stack of drill rods. It is contemplated that numerous drill rods can be disposed within a drill rod stack. It is further contemplated that the drill rods in the stack can be fed toward one end of the stack by gravity, such that when the last drill rod (located at the end of the stack) is removed and a vacant position is created, the remaining drill rods advance toward the end of the sloop, placing a new drill rod into the vacant position. In some aspects, this configuration (drill rods disposed within a drill rod stack) can place significant loads on the last drill rod, causing interference with the removal and/or clamping of that drill rod.

In further aspects, the separator wedge 200 can be placed between the last drill rod and an adjacent drill rod, thereby creating separation between the last drill rod and the adjacent drill rod. In these aspects, it is contemplated that the separation between the drill rods can aid in accessing and clamping the last drill rod. For example, it is contemplated that after the separator wedge 200 is inserted between the last and the adjacent drill rods, the drill rod clamping device 100 can be configured to enter the stack and clamp the last drill rod.

In exemplary aspects, the separator wedge 200 can be the first element disposed on the loading arm that makes contact with the stack of drill rods. In these aspects, it is contemplated that the separator wedge 200 can be secured to the loading arm in a manner that permits movement of the separator wedge 200 relative to the loading arm. It is further contemplated that the separator wedge 200 can be configured to move relative to the loading arm after the separator wedge 200 penetrates between the target drill rod and an adjacent drill rod, such that the loading arm is permitted to approach the target drill rod. Alternatively, in another aspect, the separator wedge 200 can be configured to move relative to the drill rod clamping device 100 such that, when the separator wedge 200 penetrates between the target drill rod and an adjacent drill rod, the drill rod clamping device 100 can move relative to the separator wedge 200 and clamp the target drill rod, as described above.

In further exemplary aspects, the separator wedge 200 can be selectively removable and/or replaceable such that one separator wedge 200 can be removed and/or replaced from the loading arm and/or the drill rod clamping device 100. Optionally, it is contemplated that the separator wedge 200 can comprise a thermoplastic or other soft but rigid material to thereby prevent and/or reduce damage to the drill rods. In one exemplary aspect, the separator wedge 200 can comprise glass-filled nylon and/or polycarbonate. Alternatively, the separator wedge 200 can comprise a metal (e.g., steel) and be coated and/or over-molded with one or more thermoplastic and/or elastomeric materials. In one aspect, the separator wedge 200 can have a high gloss finish and/or other surface treatment to thereby reduce its coefficient of friction. In an additional aspect, the separator wedge 200 can be coated with a lubricant that is configured to aid in the entry of the separator wedge 200 between the last drill rod and the adjacent drill rod.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A drill rod clamping device, comprising:
an actuating assembly;
first and second opposing jaws slideably connected to the actuating assembly, the first and second opposing jaws cooperating to define a receiving space configured to receive a drill rod; and
means for supporting the drill rod in a selected position relative to the drill rod clamping device,
wherein, upon activation of the actuating assembly, the actuating assembly is configured to selectively move the first opposing jaw in a first direction toward the receiving space and to selectively move the second opposing jaw in a second direction toward the receiving space such that the opposing jaws are urged toward one another and into a closed position, and wherein, in the closed position, the first and second opposing jaws are configured to clamp the drill rod.

2. The drill rod clamping device of claim 1, wherein, upon activation of the actuating assembly, the actuating assembly is configured to move the first and second opposing jaws at substantially the same speed and in opposing directions with respect to the drill rod clamping device.

3. The drill rod clamping device of claim 2, wherein, in the closed position, the first and second opposing jaws are configured to exert substantially equal force on the drill rod.

4. The drill rod clamping device of claim 1, wherein the actuating assembly comprises:
a floating plate; and
a cylinder operatively secured to the floating plate and configured to selectively move the floating plate in the first direction and the second direction; and
wherein the actuating assembly is operatively coupled to the opposing jaws such that movement of the floating plate in the first direction urges the opposing jaws toward each other and movement of the floating plate in the second direction urges the opposing jaws away from each other.

5. The drill rod clamping device of claim 4, wherein the cylinder comprises:
a barrel configured to selectively receive at least one fluid; and
a piston disposed within the barrel such that movement of the at least one fluid within the barrel effects a corresponding movement of the piston in a third or fourth direction.

6. The drill rod clamping device of claim 5, further comprising a connector block operatively associated with the floating plate, wherein the piston is secured to the connector block such that movement of the piston effects a corresponding movement of the floating plate in the third or fourth direction.

7. The drill rod clamping device of claim 6, wherein the floating plate defines first and second spaced guide channels, and wherein the drill rod clamping device further comprises:
a first bearing having a center portion, the first bearing being positioned within and configured for sliding movement relative to the first guide channel; and
a second bearing having a center portion, the second bearing being positioned within and configured for sliding movement relative to the second guide channel,
wherein the first bearing is operatively secured to the first opposed jaw, and wherein the second bearing is operatively secured to the second opposed jaw.

8. The drill rod clamping device of claim 7, wherein the first bearing is fixedly secured to the first opposed jaw, wherein the second bearing is fixedly secured to the second opposed jaw, and wherein the first and second bearings are configured for rotation about their respective center portions.

9. The drill rod clamping device of claim 7, wherein, upon movement of the floating plate in the third direction by the cylinder, the first and second bearings are moved within the first and second guide channels such that the first and second bearings are forced closer to one another.

10. The drill rod clamping device of claim 9, wherein the first and second bearings are moved substantially in the respective first and second directions, and wherein, as the bearings are moved toward one another in the respective first and second directions, the first and second opposing jaws are urged toward one another in the first and second directions toward the closed position.

11. The drill rod clamping device of claim 7, wherein, upon movement of the floating plate in the fourth direction, the first and second bearings are moved within the first and second guide channels such that the first and second bearings are forced apart from one another.

12. The drill rod clamping device of claim 11, wherein the first and second bearings are moved substantially in the respective second and first directions, and wherein, as the bearings are moved apart from one another in the respective second and first directions, the first and second opposing jaws are urged apart from one another in the second and first directions toward an open position.

13. The drill rod clamping device of claim 1, further comprising one or more guide rods, each guide rod of the one or more guide rods having a longitudinal length, wherein the first and second opposing jaws are slideably coupled to the one or more guide rods such that the first and second opposing jaws are configured for sliding movement along the longitudinal lengths of the one or more guide rods.

14. The drill rod clamping device of claim 13, wherein the one or more guide rods are disposed substantially parallel to the first and second directions.

15. The drill rod clamping device of claim 1, wherein the means for supporting the drill rod comprises a back jaw having a v-shaped portion configured for engagement with a portion of the drill rod.

16. The drill rod clamping device of claim 15, wherein the back jaw is secured to the drill rod clamping device such that the back jaw is substantially stationary during clamping of the drill rod.

17. The drill rod clamping device of claim 15, wherein the back jaw is configured for selective movement toward or away from the drill rod during clamping of the drill rod.

18. The drill rod clamping device of claim 1, wherein the means for supporting the drill rod comprises a locator block removably secured to a portion of the drill rod clamping device, wherein the locator block is configured to project into the receiving space such that the drill rod contacts and engages the locator block as it is advanced toward the drill rod clamping device.

19. The drill rod clamping device of claim 18, wherein locator block is a clip-in element, and wherein the drill rod clamping device defines one or more slots configured to receive and engage corresponding portions of the locator block.

20. The drill rod clamping device of claim 1, wherein the drill rod clamping device is a selectively attachable to and removable from a drill rod handling arm.
